(19) United States
(12) Patent Application Publication
(10) Pub. No.: US 2015/0173360 A1
(43) Pub. Date: Jun. 25, 2015

(54) SYNERGISTIC AGRICULTURAL PEST CONTROL

(71) Applicant: Assaf Dotan, Kfar Varburg (IL)

(72) Inventor: Assaf Dotan, Kfar Varburg (IL)

(73) Assignee: MAKHTESHIM CHEMICAL WORKS LTD., Beer Sheva (IL)

(21) Appl. No.: 14/006,486

(22) PCT Filed: Mar. 8, 2012
(86) PCT No.: PCT/IL2012/000113

§ 371 Date: Sep. 9, 2014

Related U.S. Application Data
(60) Provisional application No. 61/466,593, filed on Mar. 23, 2011.

(51) Int. Cl. A01N 43/56; A01N 37/08

(52) U.S. Cl. CPC A01N 43/56; A01N 37/08

(57) ABSTRACT

A method for controlling agricultural insects in a crop, comprising contacting the agricultural insects or the agricultural insects' food supply, habitat, breeding grounds or locus with a synergistically effective amount of a combination of bifenthrin and fipronil is disclosed.

### FIELD OF THE INVENTION

The present invention provides an insecticidal composition, more specifically a synergistic composition, for agricultural pest control.

### BACKGROUND OF THE INVENTION

Fipronil is a broad-spectrum phenylpyrazole insecticide used to control ants, beetles, cockroaches, fleas, ticks, termites, mole crickets, thrips, rootworms, weevils and other insects. Fipronil blocks GABA_{A}-gated chloride channels in the central nervous system. Disruption of the GABA_{A} receptors by fipronil prevents the uptake of chloride ions resulting in excess neuronal stimulation and death of the target insect.

Bifenthrin is a member of the synthetic pyrethroid family of pesticides. Like most pyrethroid pesticides, bifenthrin affects the central and peripheral nervous system of insects causing paralysis (Miller and Salgado, The Pyrethroid Insecticides; Leahy, J. P., Ed., Taylor & Francis, London; 43-97, 1985). Bifenthrin is found to be effective in controlling spiders, mosquitoes, cockroaches, ticks and fleas, pillbugs, chinch bugs, earwigs, millipedes, and termites.

US 2010/0144819 (A1) teaches a composition comprising a combination of bifenthrin and fipronil and a method of controlling of cockroaches or spiders employing the composition. However, the publication does not disclose whether a mixture of bifenthrin and fipronil will be suitable in agricultural pest control.

U.S. Pat. No. 5,747,519 (A) teaches a termite control composition for soil treatment containing bifenthrin and fipronil, and a method of controlling termites using said composition. However, the publication does not disclose whether a mixture of bifenthrin and fipronil will be suitable in agricultural pest control.

US 2011/0039907 teaches a method of ant control using mixtures of fipronil and a pyrethroid insecticide such as bifenthrin particularly in yards, gardens, parks, lawns and golf courses.

However, this document does not exemplify any activity to specifically control ants with a mixture of fipronil and bifenthrin.

Agricultural insects are very destructive to crop plants and can significantly reduce crop yields and quality and therefore, agricultural pest control has become one of the major management components of the total crop production system.

This disclosure fulfills such a need by providing a synergistic insecticidal composition which contains a combination of bifenthrin and fipronil and a method for synergistic agricultural pest control.

### SUMMARY OF THE INVENTION

According to one aspect of the invention there is provided a method for controlling agricultural insects in a crop, comprising contacting the agricultural insects or the agricultural insects' food supply, habitat, breeding grounds or locus with a synergistically effective amount of a combination of bifenthrin and fipronil.

According to another aspect of the invention there is provided use of a composition comprising a synergistic combination of bifenthrin and fipronil for controlling agricultural insects in a crop or locus thereof.

According to additional aspect of the invention there is provided a composition comprising a synergistic combination of bifenthrin and fipronil for use in controlling agricultural insects in a crop or locus thereof.

According to a further aspect of the invention there is provided a kit comprising (a) at least one container including bifentrin; (b) at least one container including fipronil; and (c) instructions for applying a combination of said bifentrin and said fipronil onto a crop or a locus where control of the insect is desired.

According to another aspect there is provided a kit comprising (a) at least one container including a combination of bifentrin and fipronil, and (b) instructions for applying said combination onto a crop or a locus where control of the insect is desired.

### DETAILED DESCRIPTION OF THE INVENTION

Prior to setting forth the invention in detail, it may be helpful to provide definitions of certain terms to be used herein. Unless defined otherwise, all technical and scientific terms used herein have the same meaning as is commonly understood by one of skill in the art to which this invention belongs.

As used herein the term “crop” includes reference to whole plant, plant organ (e.g., leaves, stems, twigs, roots, trunks, limbs, shoots, fruits etc.), or plant cells. This term also encompasses mushrooms.

As used herein the term “propagation material” is to be understood to denote all the generative parts of the plant such as seeds and spores, vegetative structures such as bulbs, corms, tubers, rhizomes, roots stems, basal shoots, stolons and buds.

It has been found that the combination of bifenthrin and fipronil results in a synergistic pesticidal activity when applied to agricultural insects. A pesticidal composition comprising a combination of bifenthrin and fipronil improves effectiveness of the pesticidal activity, broadens the spectrum of control and allows minimizing the dosages of bifenthrin and fipronil being used when compared to the use of such individual pesticides alone.

According to the invention there is provided a synergistic insecticidal composition that comprises a combination of bifenthrin and fipronil in a synergistically effective amount.

Further, there is provided an insecticidal composition comprising bifenthrin and fipronil in a synergistically effective amount, and an agriculturally acceptable carrier.

The composition may be for use in controlling agricultural insects in a crop comprising contacting the agricultural insects or the agricultural insects' food supply, habitat, breeding grounds or locus with a synergistically effective amount of a combination of bifenthrin and fipronil.

The invention relates to a method for controlling agricultural insects in a crop, comprising contacting the agricultural insects or the agricultural insects' food supply, habitat, breeding grounds or locus with a synergistically effective amount of a combination of bifenthrin and fipronil.

In one embodiment the ratio by weight of bifenthrin to fipronil is from 1:10 to 10:1.

In another embodiment the ratio by weight of bifenthrin to fipronil is from 1:5 to 5:1.

As used herein the terms “ha” refers to hectare.

According to a specific embodiment, the application rates of bifenthrin are from 1 g/ha to 50 g/ha.

According to a specific embodiment the application rates of fipronil are from 1 g/ha to 50 g/ha.

According to certain embodiments the application rates of the combination of bifenthrin and fipronil are from 1 g/ha to 1000 g/ha.

In a preferred embodiment the habitat comprises a crop or soil or water in which the crop is growing.

In a embodiment the bifentrin and the fipronil are applied concomitantly or sequentially.

The invention additionally relates to use of a composition comprising a synergistic combination of bifenthrin and fipronil for controlling agricultural insects in a crop or locus thereof.

The invention further relates to a composition comprising a synergistic combination of bifenthrin and fipronil for use in controlling agricultural insects in a crop or locus thereof.

Moreover, the invention relates to a kit comprising (a) at least one container including bifentrin; (b) at least one container including fipronil; and (c) instructions for applying a combination of said bifentrin and said fipronil onto a crop or a locus where control of the insect is desired.

According to an embodiment of the invention bifentrin and fipronil are applied concomitantly or sequentially.

Further, the invention relates to a kit comprising (a) at least one container including a combination of bifentrin and fipronil, and (b) instructions for applying said combination onto a crop or a locus where control of the insect is desired.

Thus, an enhanced, synergistic insecticidal activity is observed when an insecticidal composition that comprises a combination of bifenthrin and fipronil is used for the control of agricultural insects.

In an embodiment, the ratio (by weight) of bifenthrin to fipronil is from 1:50 to 50:1.

In an embodiment, the ratio (by weight) of bifenthrin to fipronil is from 1:10 to 10:1. In yet another embodiment the ratio (by weight) of bifenthrin to fipronil is from 1:5 to 5:1. In yet another embodiment the ratio (by weight) of bifenthrin to fipronil is from 1:2 to 2:1.

In another embodiment, the ratio (by weight) of bifenthrin to fipronil is 1:6. In yet another embodiment, the ratio (by weight) of bifenthrin to fipronil is 1:4.5. In yet another embodiment, the ratio (by weight) of bifenthrin to fipronil is 1:3. In yet another embodiment, the ratio (by weight) of bifenthrin to fipronil is 1:2.25. In yet another embodiment, the ratio (by weight) of bifenthrin to fipronil is 1:2. In yet another embodiment, the ratio (by weight) of bifenthrin to fipronil is 1:1.5. In yet another embodiment, the ratio (by weight) of bifenthrin to fipronil is 1:1.125. In yet another embodiment, the ratio (by weight) of bifenthrin to fipronil is 1:1. In yet another embodiment, the ratio (by weight) of bifenthrin to fipronil is 1.33:1. In yet another embodiment, the ratio (by weight) of bifenthrin to fipronil is 2:1. In yet another embodiment, the ratio (by weight) of bifenthrin to fipronil is 2.7:1.

The weight ratio of bifenthrin to fipronil may be an intermediate range selected from the above indicated ratios.

In an embodiment, the ratio (by weight) of bifenthrin to fipronil is 1:50 and/or above this ratio.

In an embodiment, the ratio (by weight) of bifenthrin to fipronil is 1:10 and/or above this ratio.

In an embodiment, the ratio (by weight) of bifenthrin to fipronil is 1:7.5 and/or above this ratio.

In an embodiment, the ratio (by weight) of bifenthrin to fipronil is 1:6 and/or above this ratio.

In an embodiment, the ratio (by weight) of bifenthrin to fipronil is 1:5 and/or above this ratio.

In an embodiment, the ratio (by weight) of bifenthrin to fipronil is 1:4.5 and/or above this ratio.

In an embodiment, the ratio (by weight) of bifenthrin to fipronil is 1:4 and/or above this ratio.

In an embodiment, the ratio (by weight) of bifenthrin to fipronil is 1:3.5 and/or above this ratio.

In an embodiment, the ratio (by weight) of bifenthrin to fipronil is 1:3 and/or above this ratio.

In an embodiment, the ratio (by weight) of bifenthrin to fipronil is 1:2.5 and/or above this ratio.

In an embodiment, the ratio (by weight) of bifenthrin to fipronil is 1:2 and/or above this ratio.

In an embodiment, the ratio (by weight) of bifenthrin to fipronil is 1:1.5 and/or above this ratio.

In an embodiment, the ratio (by weight) of bifenthrin to fipronil is 1:1.25 and/or above this ratio.

In an embodiment, the ratio (by weight) of bifenthrin to fipronil is 1:1 and/or above this ratio.

In an embodiment, the ratio (by weight) of bifenthrin to fipronil is 1.33:1 and/or above this ratio.

In an embodiment, the ratio (by weight) of bifenthrin to fipronil is 2:1 and/or above this ratio.

In an embodiment, the ratio (by weight) of bifenthrin to fipronil is 2.7:1 and/or above this ratio.

In an embodiment, the ratio (by weight) of bifenthrin to fipronil is 2:1 and/or below this ratio.

In an embodiment, the ratio (by weight) of bifenthrin to fipronil is 2.5:1 and/or below this ratio.

In an embodiment, the ratio (by weight) of bifenthrin to fipronil is 3:1 and/or below this ratio.

In an embodiment, the ratio (by weight) of bifenthrin to fipronil is 4:1 and/or below this ratio.

In an embodiment, the ratio (by weight) of bifenthrin to fipronil is 5:1 and/or below this ratio.

In an embodiment, the ratio (by weight) of bifenthrin to fipronil is 10:1 and/or below this ratio.

In an embodiment, the ratio (by weight) of bifenthrin to fipronil is 50:1 and/or below this ratio.

The weight ratio of bifenthrin to fipronil may be an intermediate range selected from the above indicated ratios.

In another aspect there is provided a method of protecting crops that are agriculturally important, including the propagation material thereof, such as seeds, from attack or infestation by agricultural insects, the method comprising contacting the crop, or the soil or water in which the crop is growing, with a synergistically effective amount of bifenthrin and fipronil and an agriculturally acceptable carrier.

In another aspect, a method for control of agricultural insects in crop that are agriculturally important or in propagation material thereof, by contacting the agricultural insect or their food supply, habitat, breeding grounds or their locus with a synergistically effective amount of a combination of bifenthrin and fipronil is provided. The application may be by any method known in the art, particularly, by methods such as by spraying, dipping, dusting, dressing, coating and soaking.

In another aspect there is provided a method of protecting a crop, including the propagation material thereof, such as seeds, from attack or infestation by agricultural insects, the method comprising contacting the crop, or the soil or water in which the crop is growing, with a composition comprising a synergistically effective amount of bifenthrin and fipronil and an agriculturally acceptable carrier.

In another aspect, there is provided a method for control of agricultural insects in a crop, including the propagation material thereof, by contacting the agricultural insect or their food supply, habitat, breeding grounds or their locus with a synergistically effective amount of a combination of bifenthrin and fipronil.

In another aspect, there is provided a method of protecting a crop from attack or infestation by agricultural insects comprising contacting the crop, or the soil or water in which the crop is growing, with a synergistically effective amount of a combination of bifenthrin and fipronil.

In an embodiment, the crop includes vegetables, such as tomatoes, peppers, cabbage, broccoli, asparagus, artichoke, squash, lettuce, turnip, spinach, cauliflower, melon, watermelon, cucumbers, carrots, onions, cucurbits and potatoes, tobacco, cultivated mushrooms, pome and stone fruits and berries, such as walnuts, kiwi, banana, avocado, olives, passion fruit, almonds, pineapples, apples, pears, plums, peaches, and cherries, tropical and subtropical fruits, table and wine grapes, citrus fruit, such as oranges, lemons, grapefruits and limes, cotton, soybean, oil seed rape, wheat, barley, rye, triticale, oats, maize, sorghum, cereals, sunflower, peanuts, rice, corn, sugar beet, fodder beet, coffee, beans, peas, yucca, sugar cane, and clover.

In another embodiment, crop plants that tolerate the action of herbicides, fungicides or insecticides as a result of breeding, mutagenesis or genetic engineering methods are also included.

In another embodiment, the agricultural insect pests are of the order Coleoptera, such as Acanthoscelides spp. (weevils), Acanthoscclides obtectus (common bean weevil), Agrilus planipennis (emerald ash borer), Agriotes spp. (wireworms), Anoplophora glabripennis (Asian longhorned beetle), Anthonomus spp. (weevils), Anthonomus grandis (boll weevil), Aphidius spp., Apion spp. (weevils), Apogonia spp. (grubs), Ataenius spretulus (Black Turgrass Ataenius), Atomaria linearis (pygmy mangold beetle), Aulacophore spp., Bothynoderes punctiventris (beet root weevil), Bruchus spp. (weevils), Bruchus pisorum (pea weevil), Cacoesia spp., Callosobruchus maculatus (southern cow pea weevil), Carpophilus hemipteras (dried fruit beetle), Cassida vittata, Cerosterna spp, Cerotoma spp. (chrysomeids), Cerotoma trifurcata (bean leaf beetle), Ceutorhynchus spp. (weevils), Ceutorhynchus assimilis (cabbage secdpod weevil), Ceutorhynchus napi (cabbage curculio), Chaetocnema spp. (chrysomelids), Colaspis spp. (soil beetles), Conoderus scalaris, Conoderus stigmosus, Conotrachelus nenuphar (plum curculio), Cotinus nitidis (Green June beetle), Crioceris asparagi (asparagus beetle), Cryptolestes ferrugineus (rusty grain beetle), Cryptolestes pusillus (flat grain beetle), Cryptolestes turcicus (Turkish grain beetle), Ctenicera spp. (wireworms), Curculio spp. (weevils), Cyclocephala spp. (grubs), Cylindrocpturus adspersus (sunflower stem weevil), Deporaus marginatus (mango leaf-cutting weevil), Dermestcs lardarius (larder beetle), Dermestes maculates (hide beetle), Diabrotica spp. (chrysolemids), Epilachna varivestis (Mexican bean beetle), Faustinus cubae, Hylobius pales (pales weevil), Hypera spp. (weevils), Hypera postica (alfalfa weevil), Hyperdoes spp. (Hyperodes weevil), Hypothenemus hampei (coffee berry beetle), Ips spp. (engravers), Lasioderma serricome (cigarette beetle), Leptinotarsa decemlineata (Colorado potato beetle), Liogenys futscus, Liogenys suturalis, Lissorhoptrus oryzophilus (rice water weevil), Lyctus spp. (wood beetles/powder post beetles), Maecolaspis joliveti, Megascelis spp., Melanotus communis, Meligethes spp., Meligethes aeneus (blossom beetle), Melolontha mclolontha (common European cockchafer), Oberea brevis, Oberea linearis, Oryctes rhinoceros (date palm beetle), Oryzaephilus mercator (merchant grain beetle), Oryzaephilus surinamensis (sawtoothed grain beetle), Otiorhynchus spp. (weevils), Oulema melanopus (cereal leaf beetle), Oulema oryzae, Pantomorus spp. (weevils), Phyllophaga spp. (May/June beetle), Phyllophaga cuyabana, Phyllotreta spp. (chrysomelids), Phynchites spp., Popillia japonica (Japanese beetle), Prostephanus truncates (larger grain borer), Rhizopertha dominica (lesser grain borer), Rhizotrogus spp. (Eurpoean chafer), Rhynchophorus spp. (weevils), Scolytus spp. (wood beetles), Shenophorus spp. (Billbug), Sitona lineatus (pea leaf weevil), Sitophilus spp. (grain weevils), Sitophilus granaries (granary weevil), Sitophilus oryzae (rice weevil), Stegobium paniceum (drugstore beetle), Tribolium spp. (flour beetles), Tribolium castaneum (red flour beetle), Tribolium confusum (confused flour beetle), Trogoderma variabile (warehouse beetle) and Zabrus tenebioides.

In yet another embodiment, the agricultural insect pests are of the order Diptera, such as Aedes spp. (mosquitoes), Agromyza frontella (alfalfa blotch leafminer), Agromyza spp. (leaf miner flies), Anastrepha spp. (fruit flies), Anastrepha suspensa (Caribbean fruit fly), Anopheles spp. (mosquitoes), Batrocera spp. (fruit flies), Bactrocera cucurbitae (melon fly), Bactrocera dorsalis (oriental fruit fly), Ceratitis spp. (fruit flies), Ceratitis capitata (Mediterranea fruit fly), Chrysops spp. (deer flies), Cocliliomyia spp. (screwworms), Contarinia spp. (Gall midges), Culex spp. (mosquitoes), Dasineura spp. (gall midges), Dasineura brassicae (cabbage gall midge), Delia spp., Delia platura (seedcorn maggot), Drosophila spp. (vinegar flies), Fannia spp. (filth flies), Fannia canicularis (little house fly), Fannia scalaris (latrine fly), Gasterophilus intestinalis (horse bot fly), Gracillia perseae, Haematobia irritans (horn fly), Hylemyia spp. (root maggots), Hypoderma lineatum (common cattle grub), Liriomyza spp. (leafminer flies), Liriomyza brassica (serpentine leafminer), Melophagus ovinus (sheep ked), Musca spp. (muscid flies), Musca autumnalis (face fly), Musca domestica (house fly), Oestrus ovis (sheep bot fly), Oscinella frit (grass fly), Pegomyia betae (beet leafminer), Phorbia spp., Psila rosae (carrot rust fly), Rhagoletis cerasi (cherry fruit fly), Rhagoletis pomonella (apple maggot), Sitodiplosis mosellana (orange wheat blossom midge), Stomoxys calcitrans (stable fly), Tabanus spp. (horse flies) and Tipula spp. (crane flies).

In yet another embodiment, the agricultural insect pests are of the order Hemiptera, such as Acrosternum hilare (green stink bug), Blissus leucopterus (chinch bug), Calocoris norvegicus (potato mirid), Cimex hemipterus (tropical bed bug), Cimex lectularius (bed bug), Dichelops melacanthus (Dallas), Dagbertus fasciatus, Dichelops furcatus, Dysdercus suturellus (cotton stainer), Edessa meditabunda, Eurygaster maura (cereal bug), Euschistus heron, Euschistus servus (brown stink bug), Helopeltis antonii, Helopeltis theivora (tea blight plantbug), Lagynotomus spp. (stink bugs), Leptocorisa oratorius, Leptocorisa varicomis, Lygus spp. (plant bugs), Lygus hesperus (western tarnished plant bug), Maconellicoccus hirsutus, Neurocolpus longirostris, Nezara viridula (southern green stink bug), Paratrioza cockerelli, Phytocoris spp. (plant bugs), Phytocoris californicus, Phytocoris relativus, Piezodorus guildingi, Poecilocapsus lineatus (fourlined plant bug), Psallus vaccinicola, Pseudacysta perseae, Scaptocoris castanea and Triatoma spp. (bloodsucking conenose bugs/kissing bugs).

In yet another embodiment, the agricultural insect pests are of the order Homoptera, such as Acrythosiphon pisum (pea aphid), Adelges spp. (adelgids), Aleurodes proletella (cabbage whitefly), Aleurodicus disperses, Aleurothrixus floccosus (woolly whitefly), Aluacaspis spp., Amrasca bigutella bigutella, Aphrophora spp. (leafhoppers), Aonidiella aurantii (California red scale), Aphis spp. (aphids), Aphis gossypii (cotton aphid), Aphis fabae (aphid), Aphis pomi (apple aphid), Aulacorthum solani (foxglove aphid), Bemisia spp. (whiteflies), Bemisia argentifolii, Bemisia tabaci (sweetpotato whitefly), Brachycolus noxius (Russian aphid), Brachycorynella asparagi (asparagus aphid), Brevennia rehi, Brevicoryne brassicae (cabbage aphid), Ceroplastes spp. (scales), Ceroplastes rubens (red wax scale), Chionaspis spp. (scales), Chrysomphalus spp. (scales), Coccus spp. (scales), Dysaphis plantaginea (rosy apple aphid), Empoasca spp. (leafhoppers), Eriosoma lanigerum (woolly apple aphid), Icerya purchasi (cottony cushion scale), Idioscopus nitidulus (mango leafhopper), Laodelphax striatellus (smaller brown planthopper), Lepidosaphes spp., Macrosiphum spp., Macrosiphum euphorbiae (potato aphid), Macrosiphum granarium (English grain aphid), Macrosiphum rosae (rose aphid), Macrosteles quadrilineatus (aster leafhopper), Mahanarva frimbiolata, Metopolophium dirhodum (rose grain aphid), Mictis longicornis, Myzus persicae (green peach aphid), Nephotettix spp. (leafhoppers), Nephotettix cinctipes (green leafhopper), Nilaparvata lugens (brown planthopper), Parlatoria pergandii (chaff scale), Parlatoria ziziphi (ebony scale), Peregrinus maidis (corn delphacid), Philaenus spp. (spittlebugs), Phylloxera vitifoliae (grape phylloxera), Physokermes piceae (spruce bud scale), Planococcus spp. (mealybugs), Pseudococcus spp. (mealybugs), Pseudococcus brevipes (pine apple mealybug), Quadraspidiotus perniciosus (San Jose scale), Rhapalosiphum spp. (aphids), Rhapalosiphum maida (corn leaf aphid), Rhapalosiphum padi (oat bird-cherry aphid), Saissetia spp. (scales), Saissctia oleae (black scale), Schizaphis graminum (greenbug), Sitobion avenae (English grain aphid), Sogatella furcifera (white-backed planthopper), Therioaphis spp. (aphids), Toumeyella spp. (scales), Toxoptera spp. (aphids), Trialeurodes spp. (whiteflies), Trialeurodes vaporariorum (greenhouse whitefly), Trialeurodes abutiloneus (bandedwing whitefly), Unaspis spp. (scales), Unaspis yanonensis (arrowhead scale) and Zulia entreriana.

In yet another embodiment, the agricultural insect pests are of the order Lepidoptera, such as Achoea janata, Adoxophyes spp., Adoxophyes orana, Agrotis spp. (cutworms), Agrotis ipsilon (black cutworm), Alabama argillacea (cotton leafwonn), Amorbia cuneana, Amyelosis transitella (navel orangeworm), Anacamptodes defectaria, Anarsia lineatella (peach twig borer), Anomis sabulifera (jute looper), Anticarsia gemmatalis (velvetbean caterpillar), Archips argyrospila (fruittree leafroller), Archips rosana (rose leaf roller), Argyrotaenia spp. (tortricid moths), Argyrotaenia citrine (orange torrid), Autograph gamma, Bongos crunodes, Bourbon cinnabar (rice leaf folder), Bucculatrix thurberiella (cotton leafperforator), Caloptilia spp. (leaf miners), Capua reticulana, Carposina niponensis (peach fruit moth), Chilo spp., Chlumetia transversa (mango shoot borer), Choristoneura rosaceana (obliquebanded leafroller), Chrysodeixis spp., Cnaphalocerus medinalis (grass leafroller), Colias spp., Conpomorpha cramerella, Cossus cossus (carpenter moth), Crambus spp. (Sod webworms), Cydia funebrana (plum fruit moth), Cydia molesta (oriental fruit moth), Cydia nignicana (pea moth), Cydia pomonella (codling moth), Darna diducta, Diaphania spp. (stem borers), Diatraea spp. (stalk borers), Diatraea saccharalis (sugarcane borer), Diatraca graniosella (southwester corn borer), Earias spp. (bollworms), Earias insulata (Egyptian bollworm), Earias vitella (rough northern bollworm), Ecdytopopha aurantianum, Elasmopatpus lignosellus (lesser cornstalk borer), Epiphysias postruttana (light brown apple moth), Ephestia spp. (flour moths), Ephestia cautella (almond moth), Ephestia elutella (tobbaco moth), Ephestia kuehniella (Mediterranean flour moth), Epimeces spp., Epinotia aporema, Erionota thrax (banana skipper), Eupoecilia ambiguella (grape berry moth), Euxoa auxiliaris (army cutworm), Feltia spp. (cutworms), Gortyna spp. (stemborers), Grapholita molesta (oriental fruit moth), Hedylepta indicata (bean leaf webber), Helicoverpa spp. (noctuid moths), Helicoverpa armigera (cotton bollworm), Helicoverpa zea (bollworm/corn earworm), Heliothis spp. (noctuid moths), Heliothis virescens (tobacco budworm), Hellula undalis (cabbage webworm), Indarbela spp. (root borers), Keiferia lycopersicella (tomato pinworm), Leucinodes orbonalis (eggplant fruit borer), Leucoptera malifoliella, Lithocollectis spp., Lobesia botrana (grape fruit moth), Loxagrotis spp. (noctuid moths), Loxagrotis albicosta (western bean cutworm), Lymantria dispar (gypsy moth), Lyonetia clerkella (apple leaf miner), Mahasena corbetti (oil palm bagworm), Malacosoma spp. (tent caterpillars), Mamestra brassicae (cabbage armyworm), Maruca testulalis (bean pod borer), Metisa plana (bagworm), Mythimna unipuncta (true armyworm), Neoleucinodes elegantalis (small tomato borer), Nymphula depunctalis (rice caseworm), Operophthera brumata (winter moth), Ostrinia nubilalis (European corn borer), Oxydia vesulia, Pandemis ccrasana (common currant tortrix), Pandemis heparana (brown apple tortrix), Papilio demodocus, Pectinophora gossypiella (pink bollworm), Peridroma spp. (cutworms), Peridroma saucia (variegated cutworm), Perileucoptera coffeella (white coffee leafminer), Phthorimaea operculella (potato tuber moth), Phyllocnisitis citrella, Phyllonorycter spp. (leaf miners), Pieris rapae (imported cabbageworm), Plathypena scabra, Plodia interpunctella (Indian meal moth), Plutella xylostella (diamondback moth), Polychrosis viteana (grape berry moth), Prays endocarpa, Prays oleae (olive moth), Pseudaletia spp. (noctuid moths), Pseudaletia unipunctata (armyworm), Pseudoplusia includens (soybean looper), Rachiplusia nu, Scirpophaga incertulas, Sesamia spp. (stemborers), Sesamia infercns (pink rice stem borer), Sesamia nonagrioides, Setora nitens, Sitotroga cerealella (Angoumois grain moth), Sparganothis pilleriana, Spodoptera spp. (armyworms), Spodoptera exigua (beet armyworm), Spodoptera fugiperda (fall armyworm), Spodoptera littoralis (cotton leafworm), Spodoptera oridania (southern armyworm), Synanthedon spp. (root borers), Thecla basilides, Thermisia gemmatalis, Tineola bisselliella (webbing clothes moth), Trichoplusia ni (cabbage looper), Tuta absoluta, Yponomeuta spp., Zeuzera coffeae (red branch borer) and Zeuzera pyrina (leopard moth).

In yet another embodiment, the agricultural insect pests are of the order Orthoptera, such as Anabrus simplex (Mormon cricket), Gryllotalpidae (mole crickets), Locusts migratoria, Melanoplus spp. (grasshoppers), Microcentrum retinerve (angularwinged katydid), Pterophylla spp. (kaydids), chistocerca gregaria, Scudderia furcata (forktailed bush katydid) and Valanga nigricorni.

In yet another embodiment, the agricultural insect pests are of the order Thysanoptera, such as Frankliniella fusca (tobacco thrips), Frankliniella occidentalis (western flower thrips), Frankliniella shultzei Frankliniella williamsi (corn thrips), Heliothrips haemorrhaidalis (greenhouse thrips), Riphiphorothrips cruentatus, Scirtothrips spp., Scirtothrips citri (citrus thrips), Scirtothrips dorsalis (yellow tea thrips), Taeniothrips rhopalantennalis and Thrips spp.

In another embodiment, bifenthrin and fipronil can be applied simultaneously, that is jointly, or sequentially, or separately, the sequence, in the case of separate application, generally not having any effect on the result of the control measures.

The application rates for the synergistic insecticidal compositions of bifenthrin and fipronil can be influenced by many factors of the environment and the desired effect and should be determined under actual use conditions.

In an embodiment, depending on the desired effect, the application rates of the synergistic combination of bifenthrin and fipronil are from 1 g/ha to 1000 g/ha. In another embodiment, the application rates of the synergistic combination of bifenthrin and fipronil are from 1 g/ha to 500 g/ha. In yet another embodiment, the application rates of the synergistic combination of bifenthrin and fipronil are from 1 g/ha to 250 g/ha. In yet another embodiment, the application rates of the synergistic combination of bifenthrin and fipronil are from 1 g/ha to 200 g/ha. In yet another embodiment, the application rates of the synergistic combination of bifenthrin and fipronil are from 1 g/ha to 150 g/ha. In yet another embodiment, the application rates of the synergistic combination of bifenthrin and fipronil are from 1 g/ha to 100 g/ha. In yet another embodiment, the application rates of the synergistic combination of bifenthrin and fipronil are from 1 g/ha to 50 g/ha. The above ranges refer to the application rates of a combination of bifenthrin and fipronil (namely a sum of the application rate of both active ingredients).

In a specific embodiment the application rate of the synergistic combination of bifenthrin and fipronil are is selected from 1 g/ha and above, 2 g/ha and above, 4 g/ha and above, 5 g/ha and above, 10 g/ha and above, 20 g/ha and above, 30 g/ha and above, 40 g/ha and above, 50 g/ha and above, 60 g/ha and above, 70 g/ha and above, 80 g/ha and above, 90 g/ha and above, 100 g/ha and above.

In a specific embodiment the application rate of the synergistic combination of bifenthrin and fipronil are selected from 1000 g/ha and below, 500 g/ha and below, 250 g/ha and below, 200 g/ha and below, 150 g/ha and below, 100 g/ha and below, 50 g/ha and below.

The above ranges refer to the application rates of a combination of bifenthrin and fipronil (namely a sum of the application rate of both active ingredients).

In an embodiment, depending on the desired effect, the application rates of bifenthrin are from 1 g/ha to 50 g/ha. In another embodiment, the application rates of bifenthrin are from 5 g/ha to 20 g/ha.

In an embodiment, depending on the desired effect, the application rates of fipronil are from 1 g/ha to 150 g/ha, specifically 1 g/ha to 100 g/ha, more specifically from 1 g/ha to 50 g/ha. In another embodiment, the application rates of fipronil are from 5 g/ha to 30 g/ha.

In a specific embodiment the application rates of bifenthrin are selected from 1 g/ha and above, 2 g/ha and above, 5 g/ha and above. In a specific embodiment the application rates of bifenthrin are selected from 20 g/ha and below, 30 g/ha and below, 40 g/ha and below, 50 g/ha and below, 100 g/ha and below.

In a specific embodiment the application rates of fipronil are selected from 1 g/ha and above, 2 g/ha and above, 5 g/ha and above. In a specific embodiment the application rates of fipronil are selected from 150 g/ha and below, 100 g/ha and below, 50 g/ha and below, 30 g/ha and below.

The application rate may be an intermediate range selected from the above indicated application rates.

In yet another embodiment, the synergistic insecticidal composition may be applied in various mixtures or combinations of bifenthrin and fipronil, for example in a single “ready-for-use” form, or in a combined spray mixture composed from separate formulations of the single active ingredients, such as a “tank-mix” form.

In yet another embodiment, the synergistic insecticidal composition is applied in the form of a ready-for-use formulation comprising bifenthrin and fipronil. This formulation can be obtained by combining bifenthrin and fipronil in a synergistically effective amount with an agriculturally acceptable carrier, a surfactant or other application-promoting adjuvant customarily employed in formulation technology.

Synergistic insecticidal compositions containing bifenthrin and fipronil may be employed in any conventional form, for example, in the form of a twin pack, or as emulsion concentrates (EC), suspension concentrates (SC), soluble concentrates (SL), suspoemulsion (SE), oil dispersions (OD), water dispersible granules (WDG), water soluble granules (SG) and wettable powders (WP). Such compositions can be formulated using with agriculturally acceptable carriers, surfactants or other application-promoting adjuvants customarily employed in formulation technology and formulation techniques that are known in the art.

In an embodiment, the amount of the active ingredient or ingredients in the composition is 0.1-99 wt. %, specifically 0.1-95 wt. %, more specifically 0.1-90 wt. %, based on the total weight of the composition.

Examples of suitable solid carriers include mineral earths such as silica gels, silicates, talc, kaolin, attaclay, limestone, lime, chalk, bole, loess, clay, dolomite, diatomaceous earth, calcium sulfate, magnesium sulfate, magnesium oxide, sodium carbonate and bicarbonate, and sodium sulfate, ground synthetic materials, fertilizers, such as, for example, ammonium sulfate, ammonium phosphate, ammonium nitrate, ureas, and products of vegetable origin, such as cereal meal, tree bark meal, wood meal and nutshell meal, cellulose powders and other solid carriers.

Examples of suitable liquid carriers include water, alcohols such as methanol, cyclohexanol and decanol, ethylene glycol and polypropylene glycol, N,N-dimethylformamide, dimethylsulfoxide, N-alkylpyrrolidone, aromatic hydrocarbons such as alkylbenzenes and alkylnaphthalenes, paraffins, oils of olive, castor, linseed, tung, sesame, corn, peanut, cotton-seed, soybean, rape-seed and coconut, fatty acid esters, ketones such as cyclohexanone, 2-heptanone, isophorone and 4-hydroxy-4-methyl-2-pentanone and the like.

The term “surfactant”, as used herein, means an agriculturally acceptable material which imparts emulsifiability, stability, spreading, wetting, dispersibility or other surface-modifying properties. Examples of suitable surfactants include non-ionic, anionic, cationic and ampholytic types such as lignin sulfonates, fatty acid sulfonates (e.g. lauryl sulfonate), phosphate esters such as phosphate esters of alcohol alkoxylates, phosphate esters of alkylphenol alkoxylates and phosphate esters of styrylphenol ethoxylates, condensates of sulfonated naphthalene and naphthalene derivatives with formaldehyde, condensates of naphthalene or of naphthalenesulfonic acid with phenol and formaldehyde, alkylarylsulfonates, ethoxylated alkylphenols and aryl phenols, polyalkylene glycols and ethoxylated fatty alcohols.

Other ingredients, such as wetting agents, adhesives, thickeners, binders, fertilizers or anti-freeze agents, may also be added to the synergistic insecticidal composition including the combination of bifenthrin and fipronil in order to increase the stability, density and viscosity of the composition.

In an embodiment, the combined amount of bifenthrin and fipronil together in the ready-to-use formulations (compositions) is 0.1-99 wt. %

In an embodiment, the combined amount of bifenthrin and fipronil together in the ready-to-use formulations is 0.1-95 wt. %

In another embodiment, the combined amount of bifenthrin and fipronil together in the ready-to-use formulations is 0.1-90 wt. %, based on the total weight of the formulation. In yet another embodiment, the combined amount of bifenthrin and fipronil together in the ready-to-use formulations is 1-70 wt. %, based on the total weight of the formulation. In yet another embodiment, the combined amount of bifenthrin and fipronil together in the ready-to-use formulations is 1-50 wt. %, based on the total weight of the formulation. In yet another embodiment, the combined amount of bifenthrin and fipronil together in the ready-to-use formulations is 1-40 wt. %, based on the total weight of the formulation. In yet another embodiment, the combined amount of bifenthrin and fipronil together in the ready-to-use formulations is 1-30 wt. %, based on the total weight of the formulation. In yet another embodiment, the combined amount of bifenthrin and fipronil together in the ready-to-use formulations is 1-20 wt. %, based on the total weight of the formulation. In yet another embodiment, the combined amount of bifenthrin and fipronil together in the ready-to-use formulations is 1-10 wt. %, based on the total weight of the formulation. The remaining components in the formulation are for example the carrier and additives.

In another embodiment, a kit is provided, comprising a synergistic insecticidal composition of bifenthrin and fipronil as described herein, or components thereof. Such kits may comprise, in addition to the aforementioned active components, one or more additional active and/or inactive ingredients, either within the provided synergistic insecticidal composition or separately. Certain kits comprise bifenthrin and fipronil, each in a separate container, and each optionally combined with a carrier.

As noted above, the insecticidal compositions, kits and methods described herein exhibit a synergistic effect. The insecticidal compositions, kits and methods described herein can broaden the spectrum of control, and/or minimize the dosages of bifenthrin and fipronil being used when compared to the use of such individual pesticides alone.

The instructions may be in the form of printed matter, for example either as inserts or labels.

The following examples illustrate the practice of the present invention in some of its embodiments, but should not be construed as limiting the scope of the claims. Other embodiments will be apparent to one skilled in the art from consideration of the specification and examples. It is intended that the specification, including the examples, is considered exemplary only without limiting the scope and spirit of the invention.

It is appreciated that one or more features, aspects, or embodiments of the present invention can be combined with one or more other features, aspects or embodiments of the present invention.

It is recognized that all embodiments of the invention, including those specifically described for different aspects of the invention, can be combined with any other embodiments of the invention as appropriate.

### EXAMPLES

A synergistic effect exists wherever the action of a combination of active components is greater than the sum of the action of each of the components alone. Therefore, a synergistically effective amount (or an effective amount of a synergistic composition or combination) is an amount that exhibits greater insecticidal activity than the sum of the insecticidal activities of the individual components.

In the field of agriculture, it is often understood that the term “synergy” is as defined by Colby S. R. in an article entitled “Calculation of the synergistic and antagonistic responses of herbicide combinations” published in the journal Weeds, 1967, 15, p. 20-22, incorporated herein by reference in its entirety. The action expected for a given combination of two active components can be calculated as follows:

$$E = X + Y - \frac{XY}{100}$$

in which E represents the expected percentage of insecticidal control for the combination of the two insecticides at defined doses (for example equal to x and y respectively), X is the percentage of insecticidal control observed by fipronil at a defined dose (equal to x) and Y is the percentage of insecticidal control observed by bifenthrin at a defined dose (equal to y). When the percentage of insecticidal control observed for the combination is greater than the expected percentage, there is a synergistic effect.

### Example 1

A study was carried out, in a greenhouse, to determine the synergistic insecticidal effect of the insecticidal composition which comprises the mixture fipronil (Albatross® 80 WG, Irvita plant protection) and bifenthrin (Seizer® 10 EC, Makhteshim Chemical Works, Israel).

Albatross® 80 WG contains Fipronil 800 gr. A.I./kg WG. Seizer® 10 EC contains Bifenthrin 100 gr. A.I./L EC.

A field trial was conducted on Corn to evaluate the insecticidal control of Dichelops Melacanthus (green belly stink bug), with fipronil (Albatross® 80 WG) and bifenthrin (Seizer® 10 EC), alone and in combination.

For the installation of the experiment, only adult green belly stink bugs were utilized. Five green belly stink bugs were placed in each gerbox-type container, totaling 4 gerboxes for each treatment (4 repetitions), totaling 20 green belly stink bug in each treatment. The application was done on Corn plants contained in each gerbox, and the green belly stink bugs were placed only one hour after the application. Three evaluations were carried out, the first taking place 12 hours after the exposure of the green belly stink bugs (13 hours after application), the second, 24 hours after the exposure (25 hours after application) and the third 48 hours after the exposure (49 hours after application). The evaluated treatment results are presented in tables 1 to 4.

TABLE 1
Av. % control in Corn of Stink Bugs

| | Dosage | | % control | | | % control | | | | | |
|---|---|---|---|---|---|---|---|---|---|---|---|
| | (gr or | a.i. | observed | | | expected | | | Synergistic effect | | |
| AI | mL) | (gr)/ha | 12 h | 24 h | 48 h | 12 h | 24 h | 48 h | 12 h | 24 h | 48 h |
| Albatross | 37.5 | 30 | 5.0 | 35.0 | 100.0 | | | | | | |
| Seizer | 200 | 20 | 20.0 | 25.0 | 100.0 | | | | | | |
| Seizer | 150 | 15 | 5.0 | 5.0 | 75.0 | | | | | | |
| Seizer | 100 | 10 | 10.0 | 15.0 | 80.0 | | | | | | |
| Seizer | 50 | 5 | 0.0 | 0.0 | 25.0 | | | | | | |
| Albatross + | 37.5 + 200 | 30 + 20 | 65.0 | 95.0 | 100.0 | 24.0 | 51.3 | 100.0 | 2.71 | 1.85 | 1.00 |
| Seizer | | | | | | | | | | | |
| Albatross + | 37.5 + 150 | 30 + 15 | 35.0 | 75.0 | 100.0 | 9.8 | 38.3 | 100.0 | 3.59 | 1.96 | 1.00 |
| Seizer | | | | | | | | | | | |
| Albatross + | 37.5 + 100 | 30 + 10 | 5.0 | 65.0 | 90.0 | 14.5 | 44.8 | 100.0 | 0.34 | 1.45 | 0.90 |
| Seizer | | | | | | | | | | | |
| Albatross + | 37.5 + 50 | 30 + 5 | 20.0 | 50.0 | 100.0 | 5.0 | 35.0 | 100.0 | 4.00 | 1.43 | 1.00 |
| Seizer | | | | | | | | | | | |

AI (a.i.)—active ingredient;
gr—grams;
mL—milliliter;
h—hours

TABLE 2
Av. % control in Corn of Stink Bugs

| | Dosage | | % control | | | % control | | | | | |
|---|---|---|---|---|---|---|---|---|---|---|---|
| | (gr or | a.i. | observed | | | expected | | | Synergistic effect | | |
| AI | mL) | (gr)/ha | 12 h | 24 h | 48 h | 12 h | 24 h | 48 h | 12 h | 24 h | 48 h |
| Albatross | 28.125 | 22.5 | 0.0 | 10.0 | 90.0 | | | | | | |
| Seizer | 200 | 20 | 20.0 | 25.0 | 100.0 | | | | | | |
| Seizer | 150 | 15 | 5.0 | 5.0 | 75.0 | | | | | | |
| Seizer | 100 | 10 | 10.0 | 15.0 | 80.0 | | | | | | |
| Seizer | 50 | 5 | 0.0 | 0.0 | 25.0 | | | | | | |
| Albatross + | 28.125 + 200 | 22.5 + 20 | 25.0 | 55.0 | 95.0 | 20.0 | 32.5 | 100.0 | 1.25 | 1.69 | 0.95 |
| Seizer | | | | | | | | | | | |
| Albatross + | 28.125 + 150 | 22.5 + 15 | 10.0 | 50.0 | 100.0 | 5.0 | 14.5 | 97.5 | 2.00 | 3.45 | 1.03 |
| Seizer | | | | | | | | | | | |
| Albatross + | 28.125 + 100 | 22.5 + 10 | 20.0 | 55.0 | 100.0 | 10.0 | 23.5 | 98.0 | 2.00 | 2.34 | 1.02 |
| Seizer | | | | | | | | | | | |
| Albatross + | 28.125 + 50 | 22.5 + 5 | 25.0 | 40.0 | 100.0 | 0.0 | 10.0 | 92.5 | (*) | 4.00 | 1.08 |
| Seizer | | | | | | | | | | | |

AI (a.i.)—active ingredient;
gr—grams;
mL—milliliter;
h—hours
(*) Division by zero

TABLE 3
Av. % control in Corn of Stink Bugs

| | Dosage | | % control | | | % control | | | | | |
|---|---|---|---|---|---|---|---|---|---|---|---|
| | (gr or | a.i. | observed | | | expected | | | Synergistic effect | | |
| AI | mL) | (gr)/ha | 12 h | 24 h | 48 h | 12 h | 24 h | 48 h | 12 h | 24 h | 48 h |
| Albatross | 18.75 | 15 | 5.0 | 10.0 | 100.0 | | | | | | |
| Seizer | 200 | 20 | 20.0 | 25.0 | 100.0 | | | | | | |
| Seizer | 150 | 15 | 5.0 | 5.0 | 75.0 | | | | | | |
| Seizer | 100 | 10 | 10.0 | 15.0 | 80.0 | | | | | | |
| Seizer | 50 | 5 | 0.0 | 0.0 | 25.0 | | | | | | |
| Albatross + | 18.75 + 200 | 15 + 20 | 5.0 | 30.0 | 100.0 | 24.0 | 32.5 | 100.0 | 0.21 | 0.92 | 1.00 |
| Seizer | | | | | | | | | | | |
| Albatross + | 18.75 + 150 | 15 + 15 | 30.0 | 45.0 | 100.0 | 9.8 | 14.5 | 100.0 | 3.08 | 3.10 | 1.00 |
| Seizer | | | | | | | | | | | |
| Albatross + | 18.75 + 100 | 15 + 10 | 25.0 | 25.0 | 100.0 | 14.5 | 23.5 | 100.0 | 1.72 | 1.06 | 1.00 |
| Seizer | | | | | | | | | | | |
| Albatross + | 18.75 + 50 | 15 + 5 | 10.0 | 40.0 | 95.0 | 5.0 | 10.0 | 100.0 | 2.00 | 4.00 | 0.95 |
| Seizer | | | | | | | | | | | |

AI (a.i.)—active ingredient;
gr—grams;
mL—milliliter;
h—hours

TABLE 4
Av. % control in Corn of Stink Bugs

| | Dosage | | % control | | | % control | | | | | |
|---|---|---|---|---|---|---|---|---|---|---|---|
| | (gr or | a.i. | observed | | | expected | | | Synergistic effect | | |
| AI | mL) | (gr)/ha | 12 h | 24 h | 48 h | 12 h | 24 h | 48 h | 12 h | 24 h | 48 h |
| Albatross | 9.375 | 7.5 | 0.0 | 0.0 | 85.0 | | | | | | |
| Seizer | 200 | 20 | 20.0 | 25.0 | 100.0 | | | | | | |
| Seizer | 150 | 15 | 5.0 | 5.0 | 75.0 | | | | | | |
| Seizer | 100 | 10 | 10.0 | 15.0 | 80.0 | | | | | | |
| Seizer | 50 | 5 | 0.0 | 0.0 | 25.0 | | | | | | |
| Albatross + | 9.375 + 200 | 7.5 + 20 | 20.0 | 45.0 | 100.0 | 20.0 | 25.0 | 100.0 | 1.00 | 1.80 | 1.00 |
| Seizer | | | | | | | | | | | |
| Albatross + | 9.375 + 150 | 7.5 + 15 | 15.0 | 50.0 | 100.0 | 5.0 | 5.0 | 96.3 | 3.00 | 10.00 | 1.04 |
| Seizer | | | | | | | | | | | |
| Albatross + | 9.375 + 100 | 7.5 + 10 | 15.0 | 35.0 | 100.0 | 10.0 | 15.0 | 97.0 | 1.50 | 2.33 | 1.03 |
| Seizer | | | | | | | | | | | |
| Albatross + | 9.375 + 50 | 7.5 + 5 | 10.0 | 15.0 | 95.0 | 0.0 | 0.0 | 88.8 | (*) | (*) | 1.07 |
| Seizer | | | | | | | | | | | |

AI (a.i.)—active ingredient;
gr—grams;
mL—milliliter;
h—hours
(*) Division by zero

A strong synergism occurred with the fipronil and bifenthrin mixture (Albatross® 80 WG and Seizer® 10 EC), when compared to the same dosages of the isolated products after 12 and 24 hours of exposure to the products. The fipronil and bifenthrin mixture caused a better shock action, with higher controls than those of isolated products up to 24 hours of exposure to the products.

### Example 2

The trial was made in a field of sweet pepper (Capsicum annum). The experiment design used was totally randomly with 4 repetitions. The seeding distance was of 1.2 m in between rows and 0.3 m in between plants, the experimental unit was of 3 rows with 16 plants in each row giving a total of 48 plants (18 m²). The data was taken only from the 6 plants in the middle row (2.2 m²). The total trial was of 108 experiment units with a total area of 2000 m².

During the trial 4 evaluations were made, the first one before the 1^{st} application and the rest 9,16,23 days after the first application. The evaluated variables were: number of pepper weevil per plant in the 4 evaluation dates and % of affected buttons (small fruit), per unit only in the last evaluation (23 DAA).

The evaluated products were, Albatross® 20 SC (Irvita Plant Protection) [Fipronil 200 gr. A.I./L], and Selzer® 10 EC (Makhteshim Chemical Works, Israel) [Bifenthrin 100 gr. A.I./L], which were checked in 4 different dose of each one of the products and all its cross combinations (Table 5).

Av. % control in pepper of pepper weevil

| | | | % control | | | % control | | | | | |
|---|---|---|---|---|---|---|---|---|---|---|---|
| | Ratio | | observed | | | expected | | | Colby Ratio o/e | | |
| | Fipronil/ | | 9 | 16 | 23 | 9 | 16 | 23 | 9 | 16 | 23 |
| AI | Bifenthrin | gr a.i./ha | DAA | DAA | DAA | DAA | DAA | DAA | DAA | DAA | DAA |
| Albatross | | 90 | 38.5 | 58.8 | 30.4 | | | | | | |
| Seizer | | 45 | 76.9 | 76.5 | 52.2 | | | | | | |
| Seizer | | 33.6 | 61.5 | 58.8 | 69.6 | | | | | | |
| Seizer | | 22.8 | 30.7 | 64.7 | 13.0 | | | | | | |
| Seizer | | 11.4 | 15.4 | 58.8 | 39.1 | | | | | | |
| Albatross + | 2.0 | 135 | 61.5 | 70.6 | 60.9 | 85.8 | 90.3 | 66.7 | 0.72 | 0.78 | 0.91 |
| Seizer | | | | | | | | | | | |
| Albatross + | 2.7 | 123.6 | 53.8 | 88.2 | 91.3 | 76.3 | 83.0 | 78.8 | 0.71 | 1.06 | 1.16 |
| Seizer | | | | | | | | | | | |
| Albatross + | 3.9 | 112.8 | 76.9 | 58.8 | 65.2 | 57.4 | 85.5 | 39.5 | 1.34 | 0.69 | 1.65 |
| Seizer | | | | | | | | | | | |
| Albatross + | 7.9 | 101.4 | 92.3 | 70.6 | 78.3 | 47.9 | 83.0 | 57.7 | 1.93 | 0.85 | 1.36 |
| Seizer | | | | | | | | | | | |
| Albatross | | 67.2 | 61.5 | 35.3 | 52.2 | | | | | | |
| Seizer | | 45 | 76.9 | 76.5 | 52.2 | | | | | | |
| Seizer | | 33.6 | 61.5 | 58.8 | 69.6 | | | | | | |
| Seizer | | 22.8 | 30.7 | 64.7 | 13.0 | | | | | | |
| Seizer | | 11.4 | 15.4 | 58.8 | 39.1 | | | | | | |
| Albatross + | 1.5 | 112.2 | 69.2 | 82.4 | 34.8 | 91.1 | 84.8 | 77.1 | 0.76 | 0.97 | 0.45 |
| Seizer | | | | | | | | | | | |
| Albatross + | 2.0 | 100.8 | 53.8 | 82.4 | 60.9 | 85.2 | 73.4 | 85.4 | 0.63 | 1.12 | 0.71 |
| Seizer | | | | | | | | | | | |
| Albatross + | 2.9 | 90 | 46.2 | 88.2 | 56.5 | 73.3 | 77.2 | 58.4 | 0.63 | 1.14 | 0.97 |
| Seizer | | | | | | | | | | | |
| Albatross + | 5.9 | 78.6 | 61.5 | 82.4 | 65.2 | 67.4 | 73.4 | 70.9 | 0.91 | 1.12 | 0.92 |
| Seizer | | | | | | | | | | | |
| Albatross | | 45.6 | 15.4 | 0.0 | 56.5 | | | | | | |
| Seizer | | 45 | 76.9 | 76.5 | 52.2 | | | | | | |
| Seizer | | 33.6 | 61.5 | 58.8 | 69.6 | | | | | | |
| Seizer | | 22.8 | 30.7 | 64.7 | 13.0 | | | | | | |
| Seizer | | 11.4 | 15.4 | 58.8 | 39.1 | | | | | | |
| Albatross + | 1.0 | 90.6 | 92.3 | 70.6 | 52.2 | 80.5 | 76.5 | 79.2 | 1.15 | 0.92 | 0.66 |
| Seizer | | | | | | | | | | | |
| Albatross + | 1.4 | 79.2 | 61.5 | 82.4 | 91.3 | 67.4 | 58.8 | 86.8 | 0.91 | 1.40 | 1.05 |
| Seizer | | | | | | | | | | | |
| Albatross + | 2.0 | 68.4 | 46.2 | 76.4 | 52.2 | 41.4 | 64.7 | 62.2 | 1.12 | 1.18 | 0.84 |
| Seizer | | | | | | | | | | | |
| Albatross + | 4.0 | 57 | 69.2 | 70.5 | 26.1 | 28.4 | 58.8 | 73.5 | 2.44 | 1.20 | 0.35 |
| Seizer | | | | | | | | | | | |
| Albatross | | 22.8 | 23.1 | 5.9 | 8.7 | | | | | | |
| Seizer | | 45 | 76.9 | 76.5 | 52.2 | | | | | | |
| Seizer | | 33.6 | 61.5 | 58.8 | 69.6 | | | | | | |
| Seizer | | 22.8 | 30.7 | 64.7 | 13.0 | | | | | | |
| Seizer | | 11.4 | 15.4 | 58.8 | 39.1 | | | | | | |
| Albatross + | 0.5 | 67.8 | 61.5 | 70.6 | 78.3 | 82.2 | 77.9 | 56.3 | 0.75 | 0.91 | 1.39 |
| Seizer | | | | | | | | | | | |
| Albatross + | 0.7 | 56.4 | 76.9 | 76.4 | 91.3 | 70.4 | 61.2 | 72.2 | 1.09 | 1.25 | 1.26 |
| Seizer | | | | | | | | | | | |
| Albatross + | 1.0 | 45.6 | 53.8 | 70.6 | 52.2 | 46.7 | 66.8 | 20.6 | 1.15 | 1.06 | 2.53 |
| Seizer | | | | | | | | | | | |
| Albatross + | 2.0 | 34.2 | 46.2 | 41.2 | 52.2 | 34.9 | 61.2 | 44.4 | 1.32 | 0.67 | 1.17 |
| Seizer | | | | | | | | | | | |

While this invention has been shown and described with reference to preferred embodiments thereof, it will be understood by those skilled in the art that many alternatives, modifications and variations may be made thereto without departing from the spirit and scope of the invention. Accordingly, it is intended to embrace all such alternatives, modifications and variations that fall within the spirit and broad scope of the appended claims.

All publications, patents and patent applications mentioned in this specification are herein incorporated in their entirety by reference into the specification, to the same extent as if each individual publication, patent or patent application was specifically and individually indicated to be incorporated herein by reference.

1. A method for controlling agricultural insects in a crop, comprising contacting the agricultural insects or the agricultural insects' food supply, habitat, breeding grounds or locus with a synergistically effective amount of a combination of bifenthrin and fipronil.

2. The method according to claim 1, wherein the ratio by weight of bifenthrin to fipronil is from 1:10 to 10:1.

3. The method of claim 1, wherein the ratio by weight of bifenthrin to fipronil is from 1:5 to 5:1.

4. The method of claim 2, wherein, the application rates of bifenthrin are from 1 g/ha to 50 g/ha.

5. The method of claim 2, wherein, the application rates of fipronil are from 1 g/ha to 50 g/ha.

6. The method according to claim 5, wherein the application rates of the combination of bifenthrin and fipronil are from 1 g/ha to 1000 g/ha.

7. The method according to claim 1, wherein said habitat comprises a crop or soil or water in which the crop is growing.

8. The method according to claim 6, wherein said bifentrin and said fipronil are applied concomitantly or sequentially.

9. Use of a composition comprising a synergistic combination of bifenthrin and fipronil for controlling agricultural insects in a crop or locus thereof.

10. The use according to claim 9, wherein the ratio by weight of bifenthrin to fipronil in the composition is from 1:10 to 10:1.

11. The use according to claim 9, wherein the ratio by weight of bifenthrin to fipronil in the composition is from 1:5 to 5:1.

12. The use according to claim 9, wherein, the application rates of bifenthrin are from 1 g/ha to 50 g/ha.

13. The use according to claim 9, wherein, the application rates of fipronil are from 1 g/ha to 50 g/ha.

14. The use according to claim 9, wherein the application rates of the combination of bifenthrin and fipronil are from 1 g/ha to 1000 g/ha.

15. A composition comprising a synergistic combination of bifenthrin and fipronil for use in controlling agricultural insects in a crop or locus thereof.

16. A kit comprising (a) at least one container including bifentrin; (b) at least one container including fipronil; and (c) instructions for applying a combination of said bifentrin and said fipronil onto a crop or a locus where control of the insect is desired.

17. The kit of claim 16, wherein said bifentrin and said fipronil are applied concomitantly or sequentially.

18. A kit comprising (a) at least one container including a combination of bifentrin and fipronil, and (b) instructions for applying said combination onto a crop or a locus where control of the insect is desired.
